(19) United States
(12) Patent Application Publication
(10) Pub. No.: US 2007/0281141 A1
(43) Pub. Date: Dec. 6, 2007

(54) Opaque printed substrate

(75) Inventor: Christian Kohlweyer, Bad Vilbel (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/732,778

(22) Filed: Apr. 4, 2007

(30) Foreign Application Priority Data
May 18, 2006 (EP) EP 06114149.5

(51) Int. Cl. B32B 3/00

(52) U.S. Cl. 428/207

(57) ABSTRACT

An opaque printed substrate having a first unit having a first side and a second side. The first unit includes a substrate and a first application placed on the substrate. The first application is selected from the group consisting of metallic ink and ink. A second application is placed on the first unit. The second application is selected from the group consisting of metallic ink and ink and the second application differs from the first application. The opacity of the printed substrate is at least 70% and the color shift of the second application is not more than dE=3.

### FIELD OF THE INVENTION

The present invention relates generally to printed substrates used to form packages, adhesive tapes, wall coverings, surface coverings, surface linings, decorative tapes, pouches, envelopes, wraps, and labels. In particular, this invention is related to opaque printed substrates having improved opacity and which provide natural looking colors when printed.

### BACKGROUND OF THE INVENTION

There are a variety of types of packages in which consumer products are delivered to consumers. For many products, the package not only functions as a practical means for transporting and storing the product but also serves as a communication link between the seller and the consumer. Indicia such as labeling, stylized graphics, use of color and contrast, and touch and feel are all signals that can help consumers select the products they desire and forge a strong bond between the consumers and the brands of goods they purchase.

Many types of product packages do not allow the consumer to see the product contained therein. This can present a problem for retailers because unscrupulous consumers may open the package in the store to visually inspect the goods. In the most abhorrent cases, the consumer opens the package, determines the goods are not satisfactory, and leaves the opened package on the shelf. Some consumers even open a package to inspect the goods and then select an unopened package for purchase. In either case, if the package is for goods such as bandages, tissues, diapers, catamenial devices, food products, cosmetics, medicines, cleaning supplies, or detergents, the retailer is left with an opened package that may no longer be suitable for sale.

One common method for helping consumers select the right product is to design the package such that the consumer can see the product while the product is still in the package without opening the package. Packages can be formed from clear or translucent materials through which the product can be seen. A drawback to packages formed of clear or translucent materials is that the attractiveness of the product package may be less than desired because the product contained in the package can interfere with the indicia on the exterior of the package.

To overcome this deficiency, some consumer products are packaged in containers having windows through which the consumer can see the product, with the remainder of the package devoted to other means for the connecting the seller with the consumer, such as indicia. For instance, cardboard containers for spaghetti often have a window cutout that is covered with a clear film through which the consumer can see the spaghetti and judge its quality and suitability. Sellers of some types of cookies package the cookies in clear packages and indicia do not cover the entire package, thereby allowing the consumer to the see the cookies in the package without opening the package.

Many products, such as diapers, sanitary napkins, and laundry detergent are packaged in film bags. To support the highest quality artwork and indicia on the outside of the package, metal impregnated and metallised films are often used. These types of films can be essentially opaque and can be bright white or any other color desired. Thus, color of the product contained within the package does not interfere with the message conveyed on the exterior of the container. The solid color serves as the canvas upon which any indicia such as labeling, color, images, graphics or the like can be printed. One drawback to using opaque films in packaging is that the consumer is unable to see the product contained therein and the previously mentioned problems associated with consumers inspecting the contents can arise.

Printed clear or low opacity films are an alternative to opaque films and can enable consumers to see the products contained in a package. Areas of the package are left unprinted to form windows through which the consumer can see the product. In a typical application, a layer of high opacity white ink is printed over portions of the clear or translucent bag to provide for opacity. Then, additional printing on the white can be used for indicia such as labeling, artwork or the like. The white printed film forms the canvas upon which any color desired can be printed. For example, individual wrappers for sanitary napkins can be color coded to correspond with particular levels of absorbency and a window in the package can allow the consumer to see the color of the wrapper of the individual sanitary napkins without opening the package. Printed clear or low opacity films can also be designed to have opacity that varies from region to region, thereby allowing package designers to use variable opacity of the package as a design element.

The level of opacity that can be achieved by printing high opacity white over a clear or translucent film can be as high as 60 to 80%. This level of opacity can be insufficient to prevent color shifting of the printing on the exterior of the package. Color shifting of external indicia can be particularly problematic for goods that have different colors than the colors of the external indicia. Color shifting can also be a problem when the goods are individually wrapped in a material having a color that differs from the colors presented on the exterior of the package. Furthermore, color shifting can occur as the package is emptied, leaving the full portion of the package having one color and the emptied portion of the package having another color. Color shifting of external indicia, such as labeling, artwork, graphics, and the like can be a problem for sellers who use color to communicate with the consumer. Sellers may desire consistent coloring of their brand in all of the communications they have with consumers through print media, video, product packaging, and product placement to build and maintain consistent brand equity. Inconsistent colors amongst various media can weaken the power of the brand. Clear or translucent rigid printed substrates for products such as detergent, motor oil, rice, juice, and the like are subject to these same limitations.

For some products, labeling, artwork, indicia, and the like appear on both the exterior and interior of the package. To prevent the indicia on the interior of the package from interfering with the indicia on the exterior of the package and vice versa, it can be necessary to use a laminated film structure having a highly opaque core to stop the interference. Laminated films can be difficult and expensive to manufacture because the layers must be joined and more layers of film are required to form the product package.

Some consumer products packaged in film containers may also react with ink printing on the interior of the package. For instance, some detergents can react with inks used to print on the interior of film packages. A laminated package can be used to overcome this problem by covering the printed film on the product side of the package with a clear or translucent material to protect the indicia visible on the interior of the package without obscuring the indicia.

In light of the above, there is a continuing unaddressed need for opaque printed substrates that can be made with clear or low opacity films.

Additionally, there is a continuing unaddressed need for substrates having opacity that varies from region to region on the film.

Furthermore, there is a continuing unaddressed need for high opacity printed substrates in which windows can be left to allow consumers to see the contents of packages formed with opaque printed substrates.

Additionally, there is a continuing unaddressed need for high opacity printed substrates made of clear or low opacity substrates on which printing can be made on both sides of the opaque printed substrate without using a laminated substrate.

Furthermore, there is a continuing unaddressed need for high opacity printed substrates made of clear or low opacity substrates, which can be located in between the printed layers, so that both sides display different artwork, indicia and the like without using a laminated substrate.

Finally, there is a continuing unaddressed need for high opacity printed substrates made of clear or low opacity substrates that minimize color shifting of the printed artwork, indicia and the like so that such artwork or indicia retain their authenticity.

### SUMMARY OF THE INVENTION

The present invention provides an opaque printed substrate comprising a substrate, a first unit having a first side and a second side. The first unit comprises at least a first application placed on the substrate, wherein the first application comprises a metallic ink. A second unit is placed on the first unit, wherein the second unit is selected from the group consisting of a metallic ink or ink. The printed substrate has an opacity of at least 70% in at least one region and the first unit is selected such that the second unit has a color shift of not more than dE=3.

### DETAILED DESCRIPTION OF THE INVENTION

The present invention relates to opaque printed substrates. The benefits of the invention can be enjoyed in virtually all applications in which printed substrates can be used. Printed substrates can be used in product packaging, containers, wallpaper, fastening tape, decorative tape, food wraps, paper products, wipes, and the like. The invention will be disclosed herein with respect to the Figures as a preferred embodiment of product packaging.

As used herein, the term “substrate” refers to any material that can be printed on. The substrate herein is typically transparent or at least translucent. Substrates include, but are not limited to, materials such as plastics, plastic films, fabrics, papers, polymer films, non-woven webs or fabrics, woven webs or fabrics. Woven and non-woven webs can be formed from monocomponent fibers, bicomponent fibers, multiconstituent fibers, capillary channel fibers, and the like. Substrates also include blown or cast film materials in a blend of low density polyethylene and linear low density polyethylene, metallocenes, ethylene vinyl acetate, surlyn, polyethylene terephtalate, biaxially oriented polypropylene, and nylon. A substrate can be two or more substrates laminated together. A substrate can be pigmented. A substrate can be clear. As used herein, the term “pigmented substrate” refers to a substrate that is colored.

As used herein, the term “first unit” refers to one or more applications placed on a substrate. The applications are numbered as first and subsequent applications of the first unit. The first application of the first unit comprises metallic ink, such as silver pigments. The first unit can placed on all or only a portion of a substrate and can be present on one or both sides of the substrate.

When referring to the first unit, the term “first application” refers to the first material placed on a substrate. The first application comprises a metallic ink, such as silver, placed on a substrate by any means known in the art including but not limited to by hand, printing, brushing, and spraying. The first application can be applied to the entire surface of one side of the substrate.

When referring to the first unit, the term “second application” used herein means a material placed on the first application of the first unit. In a typical embodiment of the first unit, the first application is a metallic ink comprising silver pigments together with white pigments and the second application is a white ink, typically high performance white. This sequence of applications provides a transparent substrate with an opacity of at least 70% and a color shift of less than 3 with respect to further applications placed on the first unit.

“Second unit” herein refers to one or more applications placed onto the first unit, which are numbered first and subsequent applications of the second unit. The second unit can be present on one or both sides of the first unit and can cover all or only certain regions of the first unit. After the second unit has been applied the substrate has an opacity of at least 70%, typically at least 80% and in some embodiments at least 90% in at least one region.

When referring to the second unit, the term “first application” refers to the first material placed on a first unit. The first unit can comprise metallic or non-metallic ink. The second unit can comprise further applications placed on top of the first application of the second unit. The second unit typically has the function of providing color, artwork or indicia to the opaque printed substrate.

As used herein, the term “ink” refers to a colored, usually liquid, material for writing and printing. Generally, ink has four main ingredients: (1) colorant, which is composed of a pigment or mixture of pigments which define the color of the colorant, (2) resin, which is a binder that can be soluble or in a solvent and the binder holds the colorant on a substrate, (3) solvent or water to dissolve the resin, and (4) additives to adjust properties of the ink. Pigments can be organic and inorganic substances. Inks herein can be differentiated as metallic inks and non-metallic inks. As used herein, the term “metallic ink” refers to an ink to which metal flakes or powder are added as a pigment additive to the ink. Metallic inks when printed can appear to be reflective or shiny. Therefore, “non-metallic ink” herein referred to inks without such metal flakes or powder components.

As used herein, the term “ink volume” refers to the amount of ink that is deposited onto a square area of the substrate by means of an auxiliary printing device. For example, flexo printing anilox rolls with defined cup volumes are used to transfer a specific amount of a particular ink onto the substrate. As used herein “low” ink volume ranges from 1 to 6 g/m², “medium” ink volume ranges from 6.1 to 12 g/m² and “high” ink volumes ranges from 12.1 to 40 g/m².

As used herein, the term “opaque” refers to a substrate or printed substrate that has an opacity greater than or equal to 50%.

As used herein, the term “opacity” refers to the property of a substrate or printed substrate which measures the capacity of the substrate to hide or obscure from view an object placed behind the substrate relative to the point from which an observation is made. Opacity can be reported as the ratio, in percent, of the diffuse reflectance of a substrate backed by a black body having a reflectance of 0.5% to the diffuse reflectance of the same substrate backed with a white body having an absolute reflectance of 89%. Opacity can be measured as described in ASTM D 589-97, Standard Test Method for Opacity of Paper (15°/Diffuse Illuminant A, 89% Reflectance Backing and Paper Backing). A substrate high in opacity will not permit much, if any, light to pass through the substrate. A substrate having low opacity will permit much, if not nearly all, light to pass through the substrate. Opacity can range from 0 to 100%. As used herein, the term “low opacity” refers to a substrate or printed substrate having opacity less than 50%. As used herein, the term “high opacity” refers to a substrate or printed substrate having opacity greater than or equal to 50%.

As used herein, the term “color shift” refers to the property of a printed or pigmented substrate which measures the deviation of any color thereon versus the standard of that color. Color standards are for instance defined in the PMS pantone color scheme. According to British Standard 6923, colors are quantified via L, a and b values, and its deviation via ‘dE CMC’ units. Color measurements can be executed for example by a spectrophotometer as described in ASTM E-1349.

As used herein, the term “low gauge” refers to a substrate having a thickness less than 250 microns.

As used herein, the term “clear substrate” refers to a substrate or a window of a substrate through which objects can be viewed and the objects on one side of the substrate when viewed from the other side of the substrate appear substantially the same with respect to color and shape as if there were no substrate between the viewer and the object.

As used herein, the term “substantially clear” refers to a substrate or a window in a substrate through which objects can be viewed and the objects on one side of the substrate when viewed from the other side of the substrate appear nearly the same with respect to color and shape as if there were no substrate between the viewer and the object, although the color and shape can be slightly distorted.

As used herein, the term “indicia” refers to markings or indications that can be used to convey a message. The message conveyed can be an indication of source, the characteristics of a product in a package, the quantity of a product in a package, the quality of a product in a package, or any other message. Indicia can be a single color such as a light pink to indicate the source of a particular building insulation. Indicia can be a symbol such as a graphic resembling a target used for training archers to indicate a particular retail store. Indicia can be text in any language or combination of languages representative of verbal communication. Indicia can be patterns of colors, lines, or combinations thereof such as that often appearing on Scottish kilts and possibly used to indicate the source of an adhesive tape. Indicia can be illustrations of tangible objects such as an apple indicating the source of a particular brand of computer. Indicia can be artwork depicting tangible objects or imaginary compositions or any kind of marking. A single dot of a single color can be indicia. Indicia can be the type, texture, smell, or sound when rustled of the material used to form a package. Indicia can be a combination of any and all of the indicia described previously.

As used herein, the term “disposable absorbent articles” refers to catamenial devices, sanitary napkins, panti-liners, tampons, diapers, incontinence devices, wipes, facial tissue, paper towels, toilet paper, and the like.

As used herein, the term “cleaning product” refers to detergents, laundry detergents in a liquid or powdered form, dishwasher detergents in a liquid or powdered form, or any other liquid, suspension, emulsion, powder, or granules used for cleaning.

As used herein, the terms “first side” and “second side” refer to the major planar like surfaces of the substrate. For example a classic sheet of notebook paper can be considered to have a first side and a second side available for writing upon. The surfaces of the first side and second side can be flat or curved or a combination of flat and curved surfaces.

The present invention can be best understood by studying the mechanisms that contribute to opacity and color shifting. Important factors are (i) the composition of inks and metal inks, (ii) the ink volume deposited onto the substrate, (iii) the combination of ink volumes, especially of those print layers that create the opaque barrier, and (iv) printing press settings and auxiliary devices used in the printing process, such as tapes fixing printing plates, web speed and drying conditions. (i) The ink composition impacts the amount of opacity created and the amount of metal impacts the color shift. It is known in the art that opacity can be increased by adding silver pigments to white ink. However, it is also known that high amounts of silver pigment result in a significant shift of colors printed on the silver pigment. Therefore a careful selection of the ink composition is a key element of the present invention. (ii) The ink volume impacts the ink layer thickness and thus also the opacity. On the other hand, high ink volumes may create processing issues, such as smearing, disruption and or delamination of ink due to incomplete drying. (iii) The combination of the ink volumes over the sequence of applications also impacts the final opacity and color shift, e.g. a combination of low-low ink volumes yields a lower opacity than a combination of medium-high ink volumes. (iv) It is known in the art that a variation of printing process parameters impacts print quality.

The present inventors have found that opacity of a printed area on a clear substrate can be maximized and at the same time color shift of a second print layer can be minimized by using a specific composition of the first application in the first unit. It has been found that a specific mixture of white pigment with silver pigment results in a very low color change, even for sensitive colors like light yellow or light pink. A preferred example for the white ink suitable therefore is High-Pigmented White 044-93203 available from Sun Chemical Europe, Wexham Springs, Framewood Road, Slough SL3 6PJ, United Kingdom. A preferred example for the silver ink suitable therefore is Silver 049-10557, also available from Sun Chemical Europe.

In order to maximize opacity and minimize color shift, the following combination of the above factors is disclosed. In a typical embodiment, the ink composition of the first application of the first unit is 50% HP White and 50% Silver, more typically, 70% HP white and 30% Silver ink, even more typically, 90% HP White and 10% Silver. Most typically, that ink composition is 93 to 95% HP White and 5-7% Silver.

In certain embodiments, the anilox cup volume in the first application of the first unit is ranging from 1 to 40 grams per square meter, typically from 5 to 25 grams per square meter, more typically, from 7 to 20 grams per square meter. Most typically, the anilox cup volume is ranging from 12 to 17 grams per square meter.

In certain embodiments, the ink composition of the second application of the first unit is 50% HP White and 50% Silver, typically, 70% HP white and 30% Silver ink, more typically, 90% HP White and 10% Silver. Most typically, that ink composition is 100% HP White and 0% Silver.

In certain embodiments, the anilox cup volume in the second application of the first unit is ranging from 1 to 40 grams per square meter, typically, from 5 to 25 grams per square meter, more typically, from 7 to 20 grams per square meter. Most typically, the anilox cup volume is ranging from 12 to 17 grams per square meter.

The ink composition in the following applications of the second unit is 100% using a color of the respective indicia. In certain embodiments, the anilox cup volume in each of the following applications is ranging from 1 to 40 grams per square meter, typically, from 2 to 20 grams per square meter, more typically, from 4 to 10 grams per square meter. Most typically, the anilox cup volume in each of the following applications is from 6 to 8 grams per square meter.

In certain embodiments, medium to hard tapes to fixate the flexo plates onto the cylinder are used, at web speeds from 50 to 500 meters per minute, typically, medium to hard tapes at web speeds from 150 to 250 meters per minute. More typically, hard tapes are used at web speeds from 180 to 200 meters per minute.

The sequence of the applications may be alternated such that the units creating the opaque barrier are located in between the other units that create the indicia colors. Thus, two different indicia, that become visible when looking at the substrate from two opposing sides, can be realized on each side of the opaque barrier layer within one single print pass.

The substrate can be any thickness. Typically the thickness of substrate is less than 6000 microns. In certain embodiments the thickness of substrate is less than 1000 microns. In other embodiments the thickness of substrate is less than 500 microns. Certain applications require the thickness of substrate to be less than 250 microns, in some cases even less than 100 microns.

For polymeric film substrates, typically the thickness of the substrate is less than 250 microns. In some embodiments the thickness of the polymeric film substrates is less than 150 microns. In other embodiments the thickness of the polymeric film substrates is less than 100 microns.

A specific substrate herein is Suominen F-700080 film available from Suominen Flexible Packaging Ltd., Vestonkatu 24, FI-33731 Tampere, Finland.

Some designers of the visual elements of product packages believe that in some designs, indicia are best placed on a material having high opacity. The opaque printed substrate herein has an opacity greater than or equal to 70%, typically 80% and in certain embodiments 90% in at least one region.

The opaque printed substrate can have opacity that is uniform about the entire plane of the opaque printed substrate. Alternatively, the opacity of the opaque printed substrate can vary from one region to another within the plane of the opaque printed substrate. For example, the opaque printed substrate in one region of the substrate may have opacity that differs from the opacity of the opaque printed substrate in an adjacent region.

The opacity of an opaque printed substrate can be low enough in some regions such that there is a low opacity region that is a window. A window can be a region of the opaque printed substrate having low opacity adjacent to a region having higher opacity. A window can be clear or be substantially clear. A window can be a region of substrate to which non-metallic ink or ink is applied, the window being essentially in plane with the opaque printed substrate. A window can be a region of substrate upon which only ink is applied. A window can be a region of substrate upon which only metallic ink is applied. The opacity of a window can be less than 50%. Typically, the opacity of a window can be less than 40%. In certain embodiments the opacity of a window can be less than 30%. In other embodiments the opacity of a window can be less than 20%. In still other embodiments the opacity of a window can be less than 10%.

Within the context of this description of a window, a window is “clear” if an object on one side of the opaque printed substrate can be viewed through a window in an opaque printed substrate and the object appear the same as if there were no material between the viewer and the object. A window can be “substantially clear” if objects on one side of the opaque printed substrate can be viewed through a window and the color of the objects is shifted, the geometry of the object distorted, or both the color of the object is shifted and the geometry of the object is distorted. A color is considered shifted when the object appears to have one color when viewed through a window and appears to have a different color when the object is viewed directly, with no window between the viewer and the object. The window can be a pigmented substrate selected to desirably shift the color of the object when viewed through the window. The window can be clear substrate on which ink or metallic ink is placed, thereby creating a window that generates a desired color shift.

The window can allow consumers to see the contents of a particular package to aid the consumer in selecting the proper package or to allow the consumer to judge the quality of the contents of a package. Where the contents of a package are sanitary napkins, the window can allow consumers to see the thickness of the sanitary napkins and the color of the over-wrapping of the sanitary napkin that can be indicative of absorptive capacity.

The window can have a classical geometric shape such as a multisided polygon including but not limited to a triangle, square, or a rectangle. The window can be circular or oval shaped. The window can have an irregular shape having straight edges, curved edges, or a combination of straight and curved edges. The window can have an irregular shape defined by the boundaries of the opaque printed substrate and indicia or combinations of the opaque printed substrate and indicia. The window can account for less than 10% of the total surface area of the opaque printed substrate. The window can account for less than 25% of the total surface area of the opaque printed substrate. The window can account for more than 50% of the total surface area of the opaque printed substrate. The window can account for more than 75% of the total surface area of the opaque printed substrate. The window can account for more than 90% of the total surface area of the opaque printed substrate.

An adhesive can be applied to opaque printed substrate to form an adhesive tape and the adhesive tape can have one or more windows. An adhesive can be applied to opaque printed substrate to form a surface cover such as wallpaper, contact paper, shelf covering, labeling tape and the surface covering can have one or more windows.

In an embodiment herein a first unit comprising a first application of metallic ink is placed on a substrate. The first application of the second unit is ink. Ink can be placed on first unit on the side of the substrate opposite to the side of the first application of the first unit has been placed. Ink can be placed on both sides of first unit thereby permitting printing that can be viewed from both sides of substrate.

In a further embodiment a first unit comprising a first application of metallic ink is placed on substrate. A second unit comprising a first application of ink can be placed on first unit on the side of substrate on which metallic ink is applied. Ink can be placed on both sides of first unit. An additional substrate can be laminated to substrate on the side of the substrate not having metallic ink. The additional substrate can be oriented such that the additional substrate is on the interior surface of a package or on the exterior surface of a package and still provide for printing that can be viewed from both the exterior and interior of a package. In a specific embodiment, the additional substrate can be a clear substrate or a pigmented substrate through which ink that is between the substrates can be seen. In certain embodiments, the additional substrate can be oriented such that the additional substrate is on the interior surface of a package to protect ink from adverse interactions with any product contained in a package. A package having the opaque printed substrate oriented in this manner can have ink viewable from outside of the package, ink can be viewable from inside of the package, and ink is protected from exposure to the contents contained within the package. The additional substrate can be the same material as substrate or different material. The additional substrate can have the same thickness as substrate or different thickness. The additional substrate can have opacity that differs from the opacity of substrate. An adhesive can be applied to opaque printed substrate to form an adhesive tape and the adhesive tape can have one or more windows. An adhesive tape made of an opaque printed substrate could have indicia visible from both sides of the adhesive tape.

In a further embodiment, the second unit representing the design or indicia is present on both sides of the first unit, i.e. at least one application of the second unit is present between the substrate and the first unit. The first unit has two applications which represent the barrier layer. Both first and second unit are present on the same side of the substrate. By such a configuration of the units and applications, respectively, it is possible to print two independent designs or indicia onto the substrate, which are separated by the barrier function of he first unit and thus do not visually interfere.

Metallic ink, ink, and the additional ink can be placed using any methods known in the art including but not limited to gravure printing, flexographic printing, and offset printing, letter press, lithography, plateless, post press, and screen printing. Gravure printing is the direct transfer of liquid ink to substrate from a metal image carrier. The image is lower than the surface of the image carrier base. Flexography printing is the direct transfer of liquid ink to substrate from a photopolymer image carrier. The image is raised above the surface of the image carrier base. Offset printing is the indirect transfer of paste ink to substrate from a rubber ‘blanket’ that is intermediate to substrate and the thin metal image carrier. Examples of plateless printing include electronic printing, ink jet printing, magnetography, ion deposition printing, direct charge deposition printing, and the Mead Cycolour Photocapsule process.

Metallic ink, ink, and the additional ink can be placed on a printing line in which the first unit is printed on substrate and properly fixed to substrate. Then the second unit is printed on the substrate and properly fixed to substrate. Both units, respectively their applications, can be applied to the substrate in one and the same printing run.

A package can be created by any method known in the art including stitching, melt bonding, chemical bonding, or adhesive to connect free edges of opaque printed substrate to form a package. Package can be made by hand or using automated machine processes known in the art.

The opaque printed substrate can be used to form a package for at least one hygiene article. Non-limiting, exemplary hygiene articles are sanitary napkins, panty liners, tampons, diapers, moistened wipes, incontinence pads or perspiration pads. The package formed from the opaque printed substrate may be provided with one or more windows. The package can be provided with an outside artwork comprising colors and/or indicia. The package can have all kinds of suitable shapes, such as top- or side gusseted bags, flow-wrapped bags and the like.

The opaque printed substrate herein can also be used as overwraps for cartons, boxes and the like. A further application of the package herein is as a bundling package for a multiplicity of smaller packages. Other applications of the opaque printed substrate herein are decorations, banderols and the like.

### EXAMPLES

An example of an opaque printed substrate includes a Substrate such as Suominen F700080 film available from Suominen Flexible Packaging Ltd., Vestonkatu 24, FI-33731 Tampere, Finland. A suitable White ink is High-Pigmented White 044-93203 (hereinafter HP white) available from Sun Chemical Europe, Wexham Springs, Framewood Road, Slough SL3 6PJ, United Kingdom. A suitable Metallic ink is Silver 049-10557 (hereinafter Silver), also available from Sun Chemical Europe. In the first application of the first unit an ink that consists of 93-95% HP White and 5-7% Silver is deposited onto the substrate. Flexo plates are attached to the print cylinder using hard tapes. The anilox cup volume is at 12.5 grams per square meter and the web speed is set at 200 m/min. In the second application of the first unit an ink that consists of 100% HP White is deposited onto the substrate. Hard tapes are used as well and the cup volume again 12.5 grams per square meter. The second unit is applied in the following applications. The applications of the second unit are applied onto the first unit at cup volumes of 7.5 grams per square meter and provide the colors of the indicia. The opacity of the opaque printed substrate after applications 1 and 2 of the first unit (HP white/silver+HP white) is 72% or greater. The color shift of white and white/silver color versus white color is dE=0.6 or less. For illustrating the second unit five exemplary colors have been selected, which are individually printed onto the first unit. The opacity of the opaque printed substrate on color Purple (Pantone PMS 2613C) is 93.8% or greater. The color shift of that color is dE=0.8 or less. The opacity of the opaque printed substrate on color Aubergine (Pantone PMS 235) is 91.1% or greater. The color shift of that color is dE=1.9 or less. The opacity of the opaque printed substrate on color Pink (Pantone PMS 219) is 80% or greater. The color shift of that color is dE=2.6 or less. The opacity of the opaque printed substrate on color Blue (Pantone PMS 306) is 79.8% or greater. The color shift of that color is dE=2.4 or less. The opacity of the opaque printed substrate on color Yellow (Pantone PMS 1235) is 73.8% or greater. The color shift of that color is dE=1.9 or less. For color shifts dE and opacities, each data point disclosed is the mean value of ten measurements.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An opaque printed substrate comprising:
a substrate,
a first unit being placed on the substrate, the first unit having a first and a second side, the first unit comprising at least a first application placed on the substrate, wherein the first application comprises a metallic ink; and
a second unit placed on the first unit, wherein the second unit comprises at least a first application comprising ink,
wherein the opaque printed substrate has an opacity of at least 70% in at least one region and the first unit is selected such that the second unit has a colour shift of not more than dE=3.

2. The opaque printed substrate of claim 1, wherein the opaque printed substrate has an opacity of at least 80% in at least one region.

3. The opaque printed substrate of claim 1, wherein the substrate is a low gauge substrate.

4. The opaque printed substrate of claim 1, wherein the substrate is a clear substrate.

5. The opaque printed substrate of claim 1, wherein the substrate is a substrate having low opacity.

6. The opaque printed substrate of claim 1, wherein the substrate is a pigmented substrate.

7. The opaque printed substrate of claim 1, wherein the first application of the first unit comprises silver metallic ink.

8. The opaque printed substrate of claim 1, wherein the first unit comprises a second application comprising white ink.

9. The opaque printed substrate of claim 1, wherein the first application of the second unit is non-metallic ink.

10. The opaque printed substrate of claim 1, wherein the second unit is placed on both sides of the first unit.

11. The opaque printed substrate of claim 10, wherein the second unit is arranged to provide independent and non-interfering colours and/or indicia on each of the sides of the first unit.

12. The opaque printed substrate of claim 1, wherein the opaque printed substrate includes a second region and wherein the opacity of the opaque printed substrate varies from the at least one region to the second region.

13. The opaque printed substrate of claim 1, wherein the opaque printed substrate has a window.

14. The opaque printed substrate of claim 1, wherein an additional substrate is laminated to the opaque printed substrate.

15. A package for disposable absorbent articles, the package comprising the opaque printed substrate of claim 1.
